(19) United States
(12) Patent Application Publication
(10) Pub. No.: US 2022/0314695 A1
(43) Pub. Date: Oct. 6, 2022

(54) Spare Tire Removal Tool

(71) Applicants: Yul Everline, Kingwood, TX (US); Mart Henry, Kingwood, TX (US)

(72) Inventors: Yul Everline, Kingwood, TX (US); Mart Henry, Kingwood, TX (US)

(21) Appl. No.: 17/348,040

(22) Filed: Jun. 15, 2021

Related U.S. Application Data
(60) Provisional application No. 63/169,458, filed on Apr. 1, 2021.

(51) Int. Cl. B60B 29/00; B62D 43/00

(52) U.S. Cl. CPC B60B 29/005; B62D 43/002; B60B 29/006

(57) ABSTRACT

This present invention relates to a spare tire removal tool for quickly and easily releasing a spare tire from the underside of a frame or chassis of a vehicle, such as a SUV, RV, truck or the like. The spare tire removal tool is comprised of two elongated poles that are removably connected to one another, and are rotated by an automatic cordless electric tool to control the turning speed and rotation of the poles for lowering a spare tire or raising a flat or otherwise damaged tire into the spare tire mount. The electric tool is preferably battery powered.

### CROSS-REFERENCE TO RELATED APPLICATION

The present application claims priority to, and the benefit of, U.S. Provisional Application No. 63/169,458, which was filed on Apr. 1, 2021 and is incorporated herein by reference in its entirety.

### FIELD OF THE INVENTION

The present invention relates generally to the field of automotive or vehicle tools. More specifically, the present invention relates to a spare tire removal tool designed to quickly, easily and automatically release a spare tire from under the chassis or back of an SUV, recreational vehicle (RV), truck or similar vehicle. The spare tire removal tool can also be used to place the tire back under the frame or chassis as well. The spare tire removal tool comprises two relatively thin poles connected together to form a longer pole or engagement device that can be attached to an automatic cordless electric ratchet or drill to rotate the device and release the spare tire to the ground. The invention offers a hassle-free method of removing spare tires and saves time and effort on the part of the user during the tire-changing process. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, people that own and/or operate a motor vehicle, such as an SUV, RV, truck or other vehicle where the spare tire is located under the frame or chassis, oftentimes need to change a tire on said vehicle. Usually, it is helpful if the vehicle's operator has some basic skill or knowledge on how to replace and repair a vehicle tire, as the need may arise anytime while travelling, and assistance may not be readily available. For example, a vehicle may suffer a flat tire which occurs when the tire is punctured by a sharp object, such as a nail or pin, which in turn causes the air inside the tire to escape and the tire to deflate. Other potential causes of flat tires include, but are not limited to, failure of or damage to the tire's valve stem, rubbing of the tire against curbs, medians or other road surfaces, shifting of a radial belt, accidents and other use or travel-related situations. A flat tire may result in the loss of control of the vehicle, and typically renders the vehicle inoperable until the tire can be repaired or replaced.

Accordingly, most vehicles are equipped with a spare tire and tools for changing the tire. Such tools include, but are not limited to, a jack, lug wrench and a release pole. The spare tire is typically attached or retained at the rear of the vehicle, in the vehicle's trunk or under the vehicle's frame or chassis, which requires that the spare tire first be released from its position so that it can be used to replace the flat or damaged tire.

Unfortunately, the process of changing a tire in traffic or alongside an active roadway is not only stressful, but also dangerous. Vehicles with flat tires are often parked on the side of the road, ideally in an area large enough to release the spare tire from its holding position and allow the owner or operator to change the flat or damaged tire. Typically, a release pole is fitted to or inserted into the crank system of the vehicle and is twisted manually to release the spare tire from the supporting clamps located under the vehicle, such as an SUV, RV, truck or other vehicle. Due to the area in which the spare tire is held, removal of the spare tire can require a good amount of strength to release the spare tire from storage. Unfortunately, individuals with limited strength and/or limited physical dexterity may be unable to easily or readily release the spare tire from its stowed position, and may require additional assistance from others, who may not be readily available. Of course, each of these problems is amplified if the owner/operator is attempting to change the tire at nighttime, in the dark or other low-light conditions or during inclement weather.

Additionally, much of the time spent changing a flat or otherwise damaged tire is spent releasing or freeing the spare tire from its stowed position. Unnecessary time spent on the side of a busy roadway can lead to accidents, serious injuries and even death. Further, once the spare tire is released from its stowed position, the user may then need to secure the flat tire back into position under the vehicle, which is also both time-consuming and laborious.

Therefore, there exists a long felt need in the art for an automotive tool that enables a user to quickly change a flat or otherwise damaged tire. More specifically, there is a long felt need in the art for a spare tire removal tool that enables an individual to quickly and easily release a spare tire from under the chassis or frame of a vehicle. Additionally, there is a long felt need in the art for a spare tire removal tool that eliminates the need for the individual to manually twist or insert the release pole into the crank system of the vehicle in order to release a spare tire from is mounting location under the vehicle. Moreover, there is a long felt need in the art for a spare tire removal tool that can be easily used by individuals with limited strength and/or physical dexterity, and that does not consume as much time as conventional tire-changing tools in releasing the spare tire and returning the flat or otherwise damaged tire back under the chassis of the vehicle. Finally, there is a long felt need in the art for a spare tire removal tool that is relatively inexpensive to manufacture, improves safety and is relatively easy to use.

The subject matter disclosed and claimed herein, in one embodiment thereof, comprises a spare tire removal or releasing tool that is designed to automatically and easily release a spare tire from a supporting mount under a vehicle. The spare tire removal tool comprises two relatively thin, elongated and rigid poles which may be removably attached to one another to form a single unitary, elongated pole. The elongated pole fits into a crank pulley or system of a vehicle, such that when the elongated pole is inserted through a crank hole or opening, an automatic cordless electric ratchet or drill can be removably attached to a proximate end of the elongated pole and used to turn or rotate the elongated pole to operate the crank pulley and lower the spare tire to the ground underneath the vehicle. The spare tire releasing tool of the present invention does not require manual twisting of the elongated pole, thereby eliminating the time-consuming and strenuous task of releasing a spare tire, thereby allowing users to save considerable time in changing a flat or otherwise damaged tire. Further, the poles and the ratchet are removably connected to each other, thereby allowing for easy transportation and storage in the vehicle when not in use.

In this manner, the novel spare tire removal tool of the present invention accomplishes all of the forgoing objectives, and provides a relatively safe, easy, convenient and quick solution to the problems of releasing a spare tire from under the vehicle chassis or frame to change a tire, and then installing the damaged tire to the storage mount, until such time as it can be repaired or properly disposed of The spare tire removal tool of the present invention is also user friendly, inasmuch as it does not require the user to manually twist a release pole to release the spare tire from its mount, and quickly enables the user to release the spare tire and put the flat tire back in the position of the spare tire in the supporting frame.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a spare tire releasing tool that is specifically designed to automatically release a spare tire from its storage mount under a vehicle chassis or frame, and install the flat or otherwise damaged tire in the mount, so that it may be transported to a repair shop or disposal facility. The spare tire releasing tool is comprised of an elongated pole-like structure comprised of two relatively thin, rigid poles which are removably connected to one another. In use, the elongated pole engages with a crank pulley or system integrated within a vehicle when the elongated pole is inserted through a crank opening or hole. An automatic cordless electric ratchet or drill can then be connected to one end of the elongated pole, in order to rotate the elongated pole to operate the crank pulley to lower the spare tire to the ground underneath the vehicle. The spare tire releasing tool does not require manual twisting of the pole, and thereby eliminates the otherwise time-consuming and strenuous task of releasing a spare tire. Similarly, once the spare tire has been properly installed on the vehicle, the process may be reversed to store the flat or otherwise damaged tire in the spare tire mount so that the same can be easily transported to a repair shop or disposal facility with minimal effort from the user.

In a further embodiment of the present invention, a spare tire release tool is disclosed and comprises a distal pole, a proximal pole, and an automatic cordless electric ratchet, collet or chuck. The distal pole is removably connected to the proximal pole at a first end, and is removably connected to a crank pulley of a vehicle at the opposite or second end. Similarly, the proximal pole is removably connected to the distal pole at one end, and removably connected to the automatic cordless electric ratchet, collet or chuck at the opposite end (i.e., nearest to the user). In use, the automatic cordless electric ratchet or drill turns the connected distal pole and proximal pole automatically and at a controlled rate of speed to lower the spare tire with little manual effort by the user. Similarly, once the spare tire has been properly installed on the vehicle, the direction of rotation of the automatic cordless electric ratchet, collet or chuck may be reversed to raise the flat or otherwise damaged tire into the spare tire mount so that the same can be safely transported to a repair shop or disposal facility with minimal effort from the user.

In yet a further embodiment of the present invention, a method to release or replace a spare tire underneath a vehicle using an automatic spare tire releasing tool is disclosed. The method comprises the steps of initially connecting two relatively thin poles to one another using slots present at the ends of each of the poles. Next, one of the poles (i.e., that which is most proximate to the user) is connected to an automatic cordless electric ratchet or drill, and the end of the other pole (i.e., that which is most distal to the user) is inserted into a crank hole or opening located at the rear of a vehicle to connect to the spare tire crank pulley or system of the vehicle. Next, the automatic cordless electric ratchet or drill starts to twist or rotate the connected poles to operate the crank pulley to lower the spare tire to the ground. The speed of the twisting or rotating can be controlled by the control buttons that are present on the automatic cordless electric ratchet or drill. Further, once the spare tire has been properly installed on the vehicle, the direction of rotation of the automatic cordless electric ratchet, collet or chuck may be reversed to raise the flat or otherwise damaged tire into the spare tire mount, so that the same can be safely transported to a repair shop or disposal facility with minimal effort from the user.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the spare tire removal tool of the present invention in accordance with the disclosed architecture, wherein the removal tool is fully assembled;

FIG. 2 illustrates a perspective view of one potential embodiment of the various components of the spare tire removal tool of the present invention in accordance with the disclosed architecture;

FIG. 3 illustrates a perspective view of one potential embodiment of the spare tire removal tool of the present invention stored in a convenient travel bag until needed in accordance with the disclosed architecture; and

FIG. 4 illustrates a perspective view of one potential embodiment of the spare tire removal tool of the present invention being used by an individual to lower a spare tire from its mount under a vehicle in accordance with the disclosed architecture.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an automotive tool that enables a user to quickly change a flat or otherwise damaged tire. More specifically, there is a long felt need in the art for a spare tire removal tool that enables an individual to quickly and easily release a spare tire from under the chassis or frame of a vehicle, and then load a flat or otherwise damaged tire into the spare tire mount for secure transportation to a repair shop or a disposal facility. Additionally, there is a long felt need in the art for a spare tire removal tool that eliminates the need for the individual to manually twist or insert the release pole into the crank system of the vehicle in order to release a spare tire from is mounting location under the vehicle. Moreover, there is a long felt need in the art for a spare tire removal tool that can be easily used by individuals with limited strength and/or physical dexterity, and that does not consume as much time as conventional tire-changing tools in releasing the spare tire and returning the flat or otherwise damaged tire back under the chassis of the vehicle. Finally, there is a long felt need in the art for a spare tire removal tool that is relatively inexpensive to manufacture, improves safety and is relatively easy to use.

The present invention, in one exemplary embodiment, is a novel spare tire releasing tool designed to automatically release a spare tire from under a vehicle. The tool is comprised of two relatively thin and rigid, metal poles that are removably connected to one another to form a single, unitary elongated pole. The elongated pole fits into a crank pulley or similar system of a vehicle when inserted through a crank opening. An automatic cordless electric ratchet or drill is then connected to the opposite end of the elongated pole and is used to rotate the elongated pole and the crank pulley to which it is attached to lower the spare tire from the spare tire mount to the ground underneath the vehicle. The spare tire releasing tool does not require manual twisting of the pole, and therefore eliminates the time-consuming and strenuous task of releasing a spare tire. The thin poles and the ratchet are removably connected to each other, thereby allowing for relatively easy disassembling and storage in the vehicle until needed.

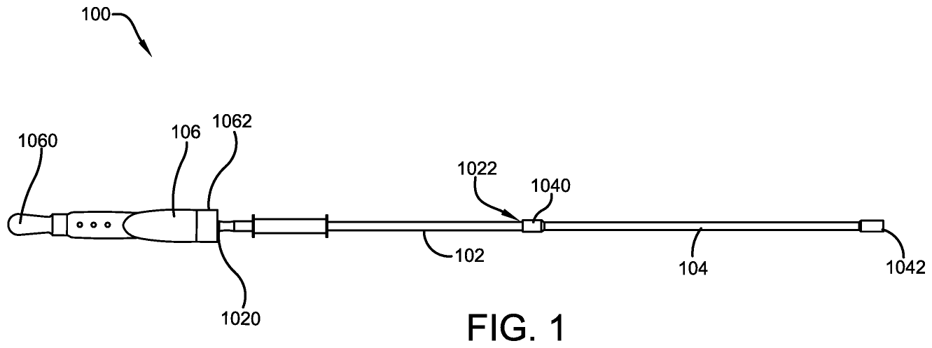

Referring initially to the drawings, FIG. 1 illustrates a perspective view of one potential embodiment of the spare tire removal tool 100 of the present invention in accordance with the disclosed architecture, wherein the removal tool 100 is fully assembled. The spare tire release tool 100 is designed to aid in the removal and release of a spare tire from a spare tire mount positioned under a vehicle, such as a truck, SUV, RV or other vehicle with a rear-mounted or concealed tire storage area. The spare tire release tool 100 is also designed to place the flat or otherwise damaged tire back under the frame quickly and easily so that it can be securely transported to a repair shop or proper disposal facility.

The spare tire release tool 100 comprises a set of removably attached poles 102, 104 that are joined together and fit under the vehicle to remove and release the spare tire, as needed. As known in the state of the art, in many SUVs, RVs and trucks, the spare tire is held or suspended from the bottom of the frame or chassis of the vehicle with a crank system. The crank system can be easily removed with the tire release tool 100, wherein a distal pole 104 is inserted into a crank hole or opening located at the rear of the vehicle from which the spare tire is to be removed.

A proximal pole 102 is held by a user in his or her hand, and can be fitted into an automatic cordless electric ratchet or drill 106 to automatically rotate the proximal pole 102 and the distal pole 104 removably attached thereto in a controlled manner and a desired direction (i.e., clockwise or counter-clockwise) using the speed control button present on the automatic cordless electric ratchet or drill 106. The cordless ratchet or drill 106 allows for both forward or clockwise and backward or counter-clockwise rotation for both lowering the spare tire and then raising the flat or damaged tire back into the supporting frame structure, respectively.

The automatic cordless electric ratchet 106 controls the speed of rotation and helps in the automatic releasing of the spare tire to the ground without any manual effort from the user. Using the automated rotation process, the process of releasing the spare tire takes about 10-15 seconds. Users with physical limitations can easily release the spare tire with the spare tire release tool 100, and the tool 100 also eliminates the time-consuming and strenuous task of releasing a spare tire from the underside of a vehicle.

The distal pole 104 and the proximal pole 102 are securely attached to each other and lock into position to have a total length which can be easily used to release the spare tire from the underside of the vehicle. The poles 102 and 104 are approximately the same length for ease of storage, with the second or distal pole 104 having a slightly greater length. The distal pole 104 can easily connect to the crank system using a far end 1042, with the far end having an end configuration that corresponds to the inlet of the crank system, such as in a lock and key configuration. The second end 1040 connects to the first end 1022 of the proximal pole 102 and is larger than the first end, thereby creating a lock and key-type arrangement so that the two ends fit securely together, and do not come apart until the tool is broken down for storage. The second end 1020 of the proximal pole 102 attaches to a first end 1062 of the cordless electric ratchet or drill 106 for completing an elongated device to help in releasing a spare tire. The tool 100 may further comprise a grip portion 1060 on the electric ratchet or drill 106 for easier releasing of the spare tire.

The diameters of the poles 102, 104 are such that they may be easily inserted into the crank hole of the vehicle, such that both of the connected poles 102, 104 are easily rotated using the cordless electric ratchet 106. In one embodiment, the distal pole 104 has a length in the range of 3-4 feet, for example, and the proximal pole 102 has length in the range of 2-3 feet, for example. The connectors allow the secure connection between the poles 102, 104 for a smooth and safe spare tire release operation. To replace the tire, the rotation is performed in the opposite direction to the direction in which the rotation is done for releasing the spare tire. The process of replacing the spare tire also takes approximately 10-15 seconds, thereby helping the user to save considerable time in repairing flat tires and getting back on the road.

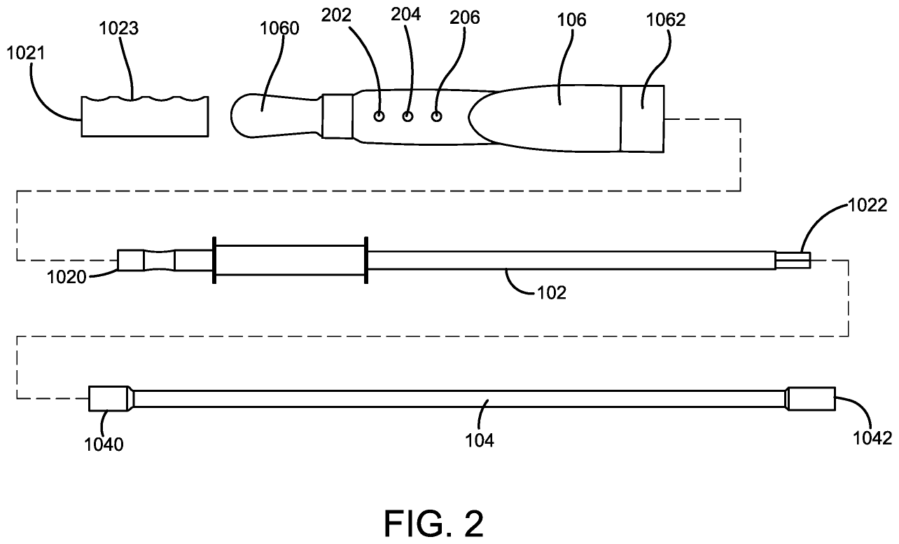

FIG. 2 illustrates a perspective view of one potential embodiment of the various components of the spare tire removal tool 100 of the present invention in accordance with the disclosed architecture. As shown, the spare tire release tool 100 has modular components. A distal pole 104 connects to the crank system of the vehicle through the far end 1042 via a lock and key-type configuration and the connects to the proximal pole 102 on the opposite side via the end 1040. The proximal pole 102 is an elongated pole like the distal pole 104 and attaches to an automatic cordless electric ratchet or drill 106 via the end 1020 and connects to the distal pole 104 via the end 1022. The end of the pole has a collet, chuck or ratchet element which enables the cordless tool to drive the poles in the desired rotational direction. The collet, chuck or ratchet element is variable so that it can be easily opened and closed on the end of the rod to secure the rod to the portable tool.

The automatic cordless electric ratchet or drill 106 has a comfortable grip 1060 to hold the automatic cordless electric ratchet or drill 106 during the operation of releasing or replacing a spare tire. Further, the electric ratchet or drill 106 is connected to the proximal pole 102 by inserting end 1020 of proximal pole 102 into first end 1062 of the electric ratchet or drill 106. The electric ratchet or drill will have a collet, chuck or ratchet element to securely hold the end of the rod in the tool element. Control buttons 202, 204, 206 are present to control the speed of rotation offered by the automatic cordless electric ratchet or drill 106. The rotation of the connected distal pole 104 and the proximal pole 102 can be easily controlled by the control buttons 202, 204, 206 of the automatic cordless electric ratchet or drill 106. As an example, control button 202 can be used to set low rotational speed, control button 204 can be used to set medium rotational speed and control button 206 can be used to set high rotational speed for the pole attached to the electric ratchet 106. However, the control buttons and their configurations are not so limited, and can be done as per the requirements of the users.

FIG. 2 also shows a manual tool hand grip 1021 with finger grip areas 1023 which may be used to rotate the pole in the event the cordless ratchet or drill does not have enough power left in the device to drive the poles to remove the tire from its carriage. In this way, the user will still have the ability to remove the tire with the elongated pole and the additional torque the pole provides the user.

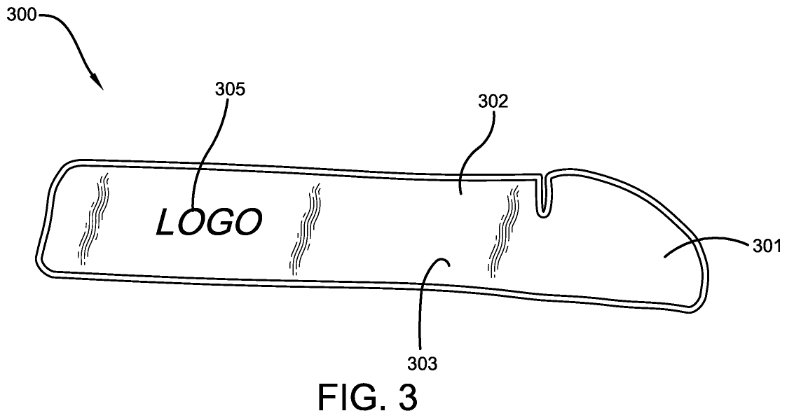

FIG. 3 illustrates a perspective view of one potential embodiment of the spare tire removal tool 100 of the present invention stored in a convenient travel bag until needed, in accordance with the disclosed architecture. As stated earlier, the spare tire release tool 100 has a plurality of modular components that are removably connected to each other for use. When the tool 100 is not being used, the individual components are disconnected and stored in the cover 300 which is dimensioned in accordance with the length of the individual poles 102, 104 and of the automatic cordless electric ratchet 106. There are separate pockets 302, 303 which are present in the cover 300 for storing the components of the tool 100. A lid or flap 301 is present which can close the opening of the cover using a hook and loop style fastener such as a VELCRO, snap button, clasp, tie, clip or combinations thereof. It should be appreciated that any other fastener may be used to secure the lid 301. The cover 300 is made up of a waterproof material and protects the tool 100 from any physical damage.

The cover 300 can be manufactured using material such as leather, plastic, vinyl, etc. as per the needs and/or preferences of the user. The cover 300 can be of any color such as black, blue, red, green or any other color which suits the requirements of the user. Additionally, the cover 300 may have printed patterns, designs, logos, customized slogans or combinations thereof 305 to provide an appealing look to the cover.

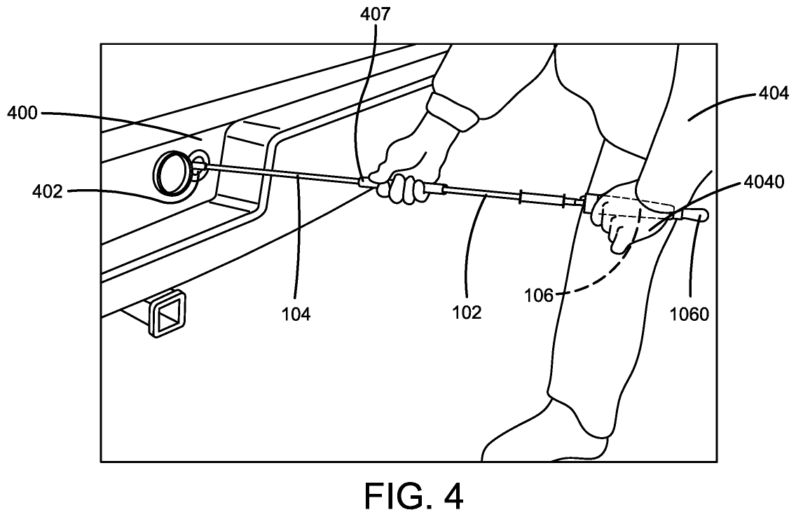

FIG. 4 illustrates a perspective view of one potential embodiment of the spare tire removal tool 100 of the present invention being used by an individual to lower a spare tire from its mount under a vehicle in accordance with the disclosed architecture. As shown, to use the tool 100, a user 404 connects the distal pole 104, the proximal pole 102, and the automatic cordless electric ratchet 106 to form an elongated member. The user 404 then inserts the distal end of the distal pole 104 into a crank opening 402 present at the rear of a vehicle 400, from which a spare tire is to be released, or to which the flat or otherwise damaged tire is to be placed. Using the control buttons present on the automatic cordless electric ratchet or drill 106, the user 404 starts automatic rotation of the connected poles 102, 104 without any manual effort and strain on the hands 4040. The speed and direction of the rotation of the poles 102, 104 can be controlled easily by the user 404 via the control buttons.

The middle portion of the proximal pole 102 has a large width for providing support to the user 404 in holding the tool 100 while releasing or replacing the spare tire. The pole may have a rotating sleeve 407 so that the user can hold the pole without it burning the skin on the hand due to the speed of the rotation, and the pole is then allowed to rotate freely for operation. It should be appreciated that the tool 100 can be used at the rear of the vehicle and underneath the vehicle. The automatic rotation of the poles does not require effort from the user 404, and the process of releasing and replacing the spare tire is completed within few seconds.

The tool 100 optimizes balance and reduces hand fatigue and offers variable speed and a reverse switch to reverse the direction of rotation of the pipes. Further, the tool 100 provides sufficient torque and avoids damage to the tools and the spare tire hoist. The tool 100 turns the crank pulley to roll a cable holding the spare tire up or down to lower the spare tire. The ratchet or drill 106 may have a Li-Ion battery. The poles are made of tough, durable materials such as steel, metal or aluminum and may be coated with corrosion-resistant finish material. The poles ensure a quality fit. They also match the original part on specified vehicles, and provide a relatively long service life.

Certain terms are used throughout the following description and claims to refer to particular features or components. As one skilled in the art will appreciate, different persons may refer to the same feature or component by different names. This document does not intend to distinguish between components or features that differ in name, but not structure or function. As used herein “spare tire release tool”, “tire release tool”, “spare tire automatic release tool”, “tool”, and “automatic turning spare tire releasing tool” are interchangeable and refer to the spare tire release tool 100 of the present invention.

Notwithstanding the forgoing, the spare tire release tool 100 of the present invention can be of any suitable size and configuration as is known in the art without affecting the overall concept of the invention, provided that it accomplishes the above-stated objectives. One of ordinary skill in the art will appreciate that the size, configuration and material of the spare tire release tool 100 as shown in the FIGS. are for illustrative purposes only, and that many other sizes and shapes of the spare tire release tool 100 are well within the scope of the present disclosure. Although the dimensions of the spare tire release tool 100 are important design parameters for user convenience, the spare tire release tool 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle accessory for changing a tire, the vehicle accessory comprising:
a first rod having a first end and a second end, wherein the first end is configured to engage a spare tire crank assembly on a vehicle;
a second rod having a distal end and a proximal end, wherein the distal end matingly engages with the second end of the first rod to form an elongated rod; and
a portable tool for engaging the proximal end of the second rod and rotating the elongated rod.

2. The vehicle accessory as recited in claim 1, wherein the portable tool is one of a ratchet or a drill.

3. The vehicle accessory as recited in claim 2, wherein the portable tool is a cordless tool and is powered by a battery.

4. The vehicle accessory as recited in claim 3, wherein the portable tool has a variable speed control and a rotation direction control.

5. The vehicle accessory as recited in claim 4, wherein the portable tool has at least one of a collet, a chuck or a ratchet to connect to the proximal end of the second rod.

6. The vehicle accessory as recited in claim 5, wherein at least one of the first and second rods is provided with a rotatable sleeve.

7. The vehicle accessory as recited in claim 6, wherein each of the first and second rods share a similar length.

8. The vehicle accessory as recited in claim 6, wherein the second rod is larger than the first rod.

9. The vehicle accessory as recited in claim 6, wherein the distal end of the second rod is larger than the first end of the first rod and the distal end of the second rod and the first end of the first rod form a lock and key arrangement to fit securely together.

10. The vehicle accessory as recited in claim 5, wherein the at least one collet, chuck or ratchet has a variable opening therein for receipt of the proximal end of the second rod.

11. A tire removal tool kit comprising:
a cover having at least one pocket;
a first rod;
a second rod, wherein the second rod is longer than the first rod; and
a portable tool.

12. The tire removal tool kit as recited in claim 11, wherein the portable tool is one of a ratchet or a drill.

13. The tire removal tool kit as recited in claim 12, wherein the portable tool is a cordless tool having at least one of a chuck, a collet or a ratchet.

14. The tire removal tool kit as recited in claim 11, wherein the first rod is comprised of a first end and a second end and the second rod is comprised of a distal end and a proximal end, and further wherein the first and second rods are connected together to form an elongated rod.

15. The tire removal tool kit as recited in claim 14, wherein the first end of the first rod corresponds to a crank assembly on a vehicle, and the proximal end of the second rod matingly engages the portable tool.

16. The tire removal tool kit as recited in claim 11 further comprising a rotatable sleeve positioned around a select one of the first and second rods.

17. The tire removal tool kit as recited in claim 16 further comprising a manual grip turning tool for use with at least one of the first and second rods.

18. The tire removal tool kit as recited in claim 14, wherein the proximal end of the second rod is larger in size than the first end of the first rod.

19. A spare tire accessing tool comprising:
an elongated rod formed from first and second poles removably connected to one another, the elongated rod having first and second ends.
the first end of the elongated rod having a configuration to fit withing a crank hole of a vehicle and the second end configured to be held by one of chuck, collet or ratchet; and
a portable tool and having the one of the chuck, collet or ratchet and for providing a rotational force to turn the elongated.

20. The spare tire accessing tool as recited in claim 19, wherein the second pole is longer than the first pole, and further wherein the first and second poles have a lock and key connection.
